(19) United States
(12) Patent Application Publication
(10) Pub. No.: US 2012/0007813 A1
(43) Pub. Date: Jan. 12, 2012

(54) TOUCH SCREEN

(75) Inventors: Kyoung Soo Chae, Gyunggi-do (KR); Hee Bum Lee, Gyunggi-do (KR); Hyun Jun Kim, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/904,839

(22) Filed: Oct. 14, 2010

(30) Foreign Application Priority Data
Jul. 7, 2010 (KR) 1020100065545

(51) Int. Cl. G06F 3/041

(52) U.S. Cl. 345/173

(57) ABSTRACT

Disclosed herein is a touch screen, including: a base member; a plurality of electrode patterns formed on one surface of the base member, having a first directionality; electrode wirings connected to both ends of the electrode patterns; and a controller that is connected to the electrode wirings, measures the change in resistance of the electrode pattern to update reference voltage variation value, and measures charging/discharging characteristics generated from the electrode pattern when an outside touch is generated to calculate coordinate information on a touched point.

### CROSS REFERENCE TO RELATED APPLICATION

This application claims the benefit of Korean Patent Application No. 10-2010-0065545, filed on Jul. 7, 2010, entitled “Touch Screen”, which is hereby incorporated by reference in its entirety into this application.

### BACKGROUND OF THE INVENTION

1. Technical Field

The present invention relates to a touch screen.

2. Description of the Related Art

With the development of the mobile communication technology, user terminals such as cellular phones, PDAs, and navigations can serve as a display unit that simply displays character information as well as a unit for providing various and complex multi-media such as audio, moving picture, radio internet web browser, etc. Due to a recent demand for a larger display screen within a terminal having a limited size, a display scheme adopting a touch screen has been more in the limelight. The touch screen combines a screen and coordinate input units, thereby saving space as compared to a key input scheme according to the prior art.

A touch screen currently and mainly used is classified into two types.

First, a resistive touch screen has a structure in which upper/lower electrode films are disposed to be spaced by a spacer and be contacted to each other by pressure. When an upper substrate on which the upper electrode film is formed is pressed by an input unit such as fingers, pens or the like, the upper/lower electrode films are conducted and the change in voltage according to the change in resistance value of the position is recognized by a controller, such that the touched coordinates are recognized.

A capacitive touch screen has a structure in which an upper substrate on which a first electrode pattern having a first directionality and a lower substrate on which a second electrode pattern having a second directionality are spaced from each other and an insulator is inserted therebetween in order to prevent the first electrode pattern from contacting the second electrode pattern.

As a touch screen is touched by an input unit, the capacitive touch screen measures the change in capacitance generated from the first electrode pattern and the second electrode pattern to calculate the coordinates of a touched point.

Meanwhile, in a touch screen according to the prior art an electrode pattern uses a conductive material, wherein the conductive material is sensitive to moisture and temperature such that a value of surface resistance is changed according to the change in the external environment. If the surface resistance of the electrode pattern is changed, accurate coordinates of the touched point cannot be calculated even though it is touched by an input unit, as a result, the touch screen loses the function thereof.

### SUMMARY OF THE INVENTION

The present invention has been made in an effort to provide a touch screen that measures the change in surface resistance of an electrode pattern and updates reference voltage variation value based on surface resistance value to accurately calculate the coordinates of a touched point even when the surface resistance value of the electrode pattern is changed according to the external environment.

A touch screen according to a preferred embodiment of the present invention includes: a base member; a plurality of electrode patterns formed on one surface of the base member, having a first directionality; electrode wirings connected to both ends of the electrode patterns; and a controller that is connected to the electrode wirings, measures the change in resistance of the electrode patterns to update reference voltage variation value, and measures voltage variation value generated from the electrode patterns when an outside touch is generated to calculate coordinate information on a touched point.

Further, the controller includes: a charging/discharging measuring unit that measures the charging/discharging characteristics of the electrode pattern to determine whether an outside touch is generated; a coordinate detecting unit that calculates coordinate information on the touched point by using the change in voltage of the charging/discharging characteristics; a resistance measuring unit that measures the change in resistance of the electrode pattern; a correction updating unit that updates the reference voltage variation value by using the resistance value of the electrode pattern measured by the resistance measuring unit; and a memory unit that stores a lookup table showing coordinate value according to the reference voltage variation value and stores the reference voltage variation value updated by the correction updating unit.

Further, the plurality of electrode patterns have the same area and shape.

Further, the plurality of electrode patterns are spaced from each other at the same interval.

The touch screen further includes a protective layer that covers the plurality of electrode patterns.

Further, the distal ends of the electrode wirings are collected at a connection unit formed on one surface of the base member.

Further, the electrode pattern is made of a conductive polymer.

Further, the conductive polymer includes PEDOT/PSS.

### BRIEF DESCRIPTION OF THE DRAWINGS

FIG. 1 is a plan view of a touch screen according to a preferred embodiment of the present invention;

FIG. 2 is a cross-sectional view of the touch screen of FIG. 1;

FIG. 3 is a side view showing a modified example of the touch screen of FIGS. 1 and 2;

FIG. 4 is a block diagram of a controller of a touch screen according to the present invention;

FIG. 5 is an equivalent circuit view formed when an outside touch is generated on a touch screen according to the present invention;

FIGS. 6 and 7 are graphs showing charging/discharging characteristics of a touch screen according to the present invention; and

FIGS. 8 and 9 are graphs showing charging/discharging characteristics of a touch screen when surface resistance is changed.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

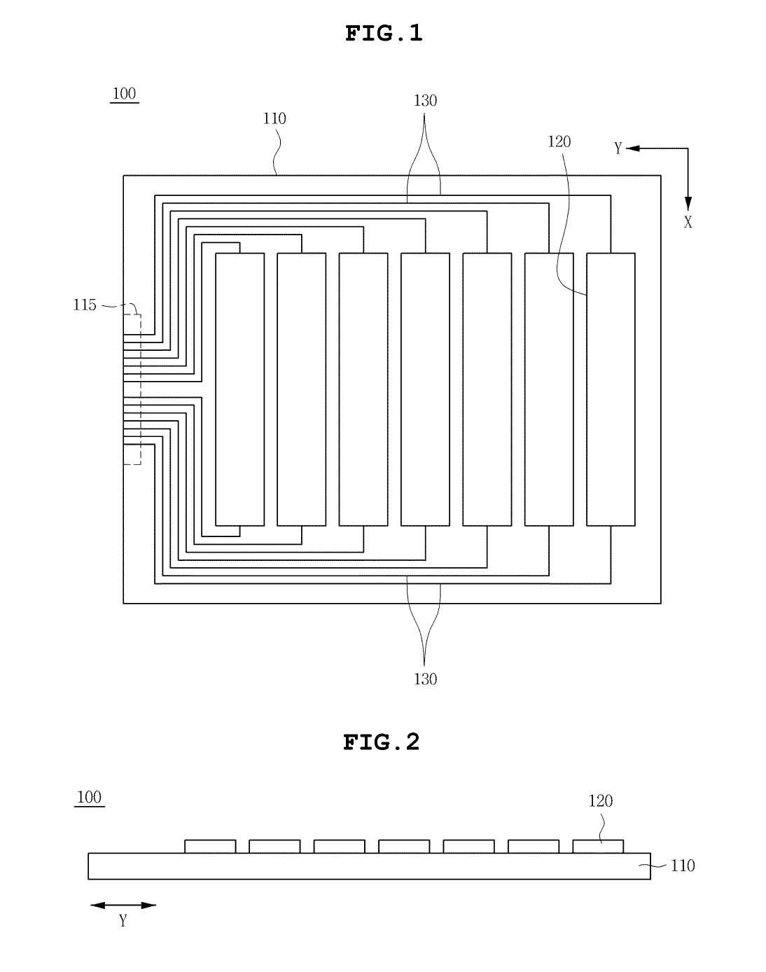

FIG. 1 is a plan view of a touch screen according to a preferred embodiment of the present invention, and FIG. 2 is a cross-sectional view of the touch screen of FIG. 1. Hereinafter, a touch screen according to the present embodiment will be described with reference to these figures.

A touch screen 100 according to the present invention includes a base member 110 including a plurality of electrode patterns 120 formed on one surface thereof.

The base member 110, which is a transparent member, may use a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylenenaphatalenedicarboxylate (PEN), polycarbonate (PC), polyethersulfone (PES), polyimide (PI), polyvinylalcohol (PVA), cyclic olefin copolymer (COC), stylene polymer, polyethylene, polypropylene, etc. The material of the base member 110 may be selected according to the kind and the use of a terminal to which the touch screen is applied.

The plurality of electrode patterns 120 are formed on one surface of the base member 110, having a first directionality.

The electrode pattern 120 may adopt a conductive material such as indium tin oxide (ITO). In this case, it is preferable that the electrode pattern 120 is made of a conductive polymer. The conductive polymer may adopt an organic compound, such as polythiophene, polypyrrole, polyaniline, polyacetylene, polyphenylene, or the like. In particular, among the polythiophene, a PEDOT/PSS compound is most preferable and at least one of the organic compounds may be mixed.

The conductive polymer is inexpensive to manufacture, while having surface resistance equivalent to ITO. The electrode pattern 120 may be formed by printing the conductive material through a known method such as a gravure printing method, an inkjet printing method, a photolithography method or the like.

The electrode pattern 120 has an extended shape having a first directionality. As shown in FIG. 1, in order to have uniform resistance, the electrode pattern has a bar shape and is formed to be parallel to adjacent electrode patterns.

It is preferable that the plurality of electrode pattern have the same area and shape. The change in capacitance generated when the touch screen is touched by an input unit is determined according to the electrode patterns and the touched area of the input unit. As a result, it is preferable that the plurality of electrode patterns have the same area and shape in order to prevent the electrode patterns, which are variable elements, from affecting the change in capacitance generated from the electrode patterns.

The plurality of electrode patterns are disposed to be spaced from each other. As a result, it is preferable that the adjacent electrode patterns are disposed at the same interval, in order to obtain the accurate coordinates of the touched point.

The base member 110 includes electrode wirings 130 connected to both ends of the electrode patterns 120 and formed on one surface of the base member 110. The electrode wirings 130 are formed in an edge region of the base member 110, wherein the edge region is an inactive region through which an image generated from a display does not pass when the touch screen is mounted on the terminal.

The electrode wiring 130 may be made of a conductive material having a small resistance such as Ag paste or be made of the same material as the electrode pattern 120.

Meanwhile, the electrode wiring 130 transfers the change in voltage according to the charging/discharging characteristics generated from the electrode pattern 120 to a controller (not shown) through a connection unit (not shown) such as an FPC. In this case, it is preferable that the distal ends of the electrode wirings 130 are collected at the connection unit 115 formed on one side of the base member 110 in order to design the connection unit such as the FPC is infrequently used.

The connection unit 115 may be formed to have various shapes, such as including a via according to the connection structure of the FPC.

The controller (not shown) connected to the electrode wirings 130 through the connection unit updates the reference voltage variation value of the charging/discharging characteristics by measuring the change in resistance of the electrode pattern 120 and calculates coordinate information on the touched point by using the charging/discharging characteristics when an outside touch is generated.

The touch screen 100 supplies a predetermined amount of charges to the electrode patterns 120 through the electrode wirings 130, wherein after the predetermined amount of charges are supplied to an RC equivalent circuit consisting of a resistance component and a capacitance component, there occurs a phenomenon that charges are redistributed according to the outside touch and the controller measures the change in voltage generated therein, thereby calculating the coordinates of the touched point.

In this case, the surface resistance of the electrode pattern 120 may be changed according to moisture and temperature, such that the controller repeatedly updates the reference voltage variation value by measuring the change in resistance of the electrode pattern. In particular, when the electrode pattern is made of a conductive polymer, the surface resistance remarkably changes (surface resistance increases as temperature and moisture increase), such that the update of the reference voltage variation value is necessary.

Meanwhile, the reference voltage variation value, which is a reference value that determines whether or not an outside touch is generated on the touch screen, is voltage variation consecutively shown according to the discharging characteristics of the RC circuit. When the voltage variation value shown on the electrode pattern has variation smaller than the reference voltage variation value (when a voltage change curve has variation smaller than a reference voltage curve on the graph), it is determined that the charges are naturally discharged and when the voltage variation value shown on the electrode pattern has variation larger than the reference voltage variation value, it is determined that an outside touch is generated. It may also be determined whether an outside touch is generated by determining whether the voltage value measured in a threshold time is more or less than the reference voltage value.

The coordinates of the touched point is also calculated using the charging/discharging characteristics. This will be described below with reference to FIGS. 4 to 9.

The reference voltage variation value is affected by the surface resistance of the electrode pattern. The voltage is applied through the electrode wirings and the current is measured, thereby obtaining the surface resistance of the electrode pattern. As a result, the reference voltage variation value representing the charging/discharging characteristics can be updated.

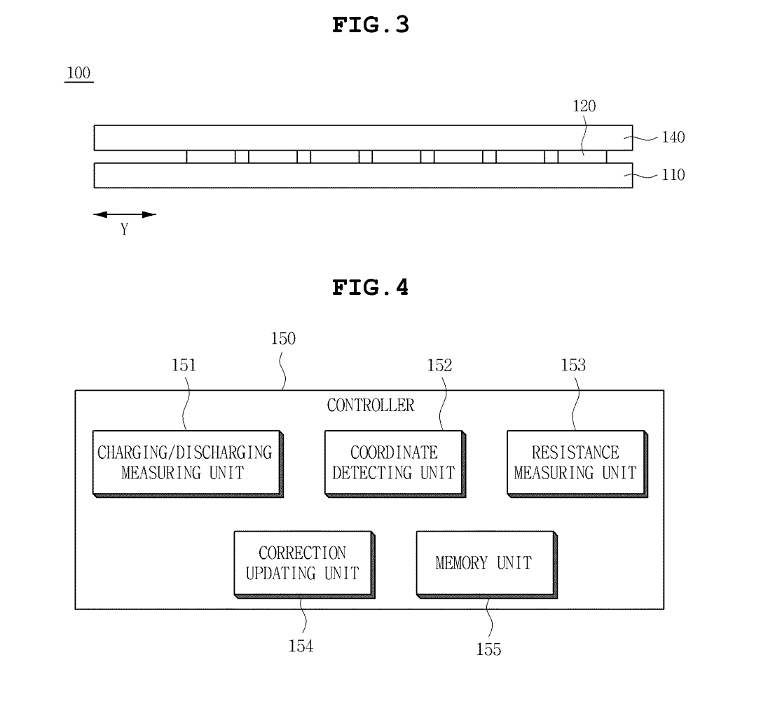

As shown in FIG. 3, the touch screen according to the present invention further includes a protective layer 140 covering the electrode patterns 120 and the electrode wirings 130.

The protective layer 140 forms a touched surface touched by an input unit and functions as dielectrics disposed between the electrode patterns 120 and the input unit.

The protective layer 140 is bonded to the base member 110 by an optical clear adhesive (not shown) so as to cover the electrode patterns and the electrode wirings, thereby protecting the electrode patterns 120 and the electrode wirings 130 from the outside. The protective layer 140 may adopt a glass substrate or a film substrate, which is transparent, similar to the base member 110.

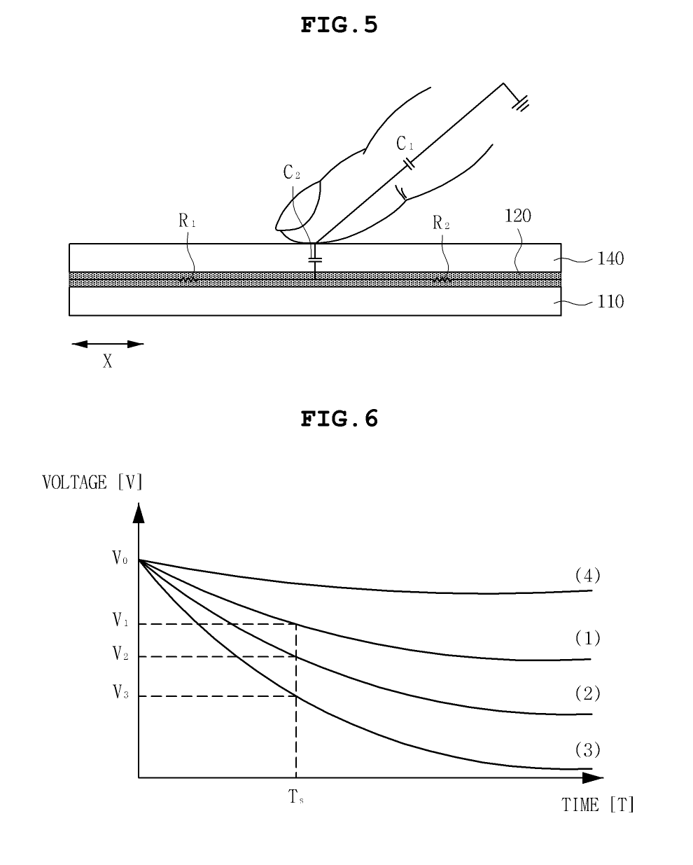

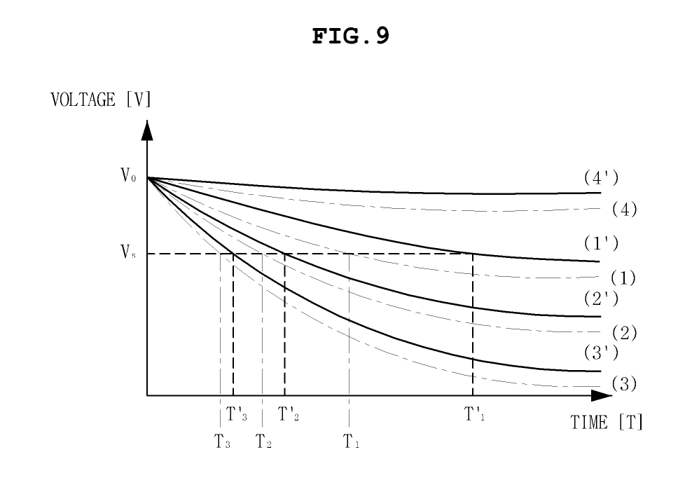

FIG. 4 is a block diagram of a controller connected to a touch screen according to the present invention, FIG. 5 is an equivalent circuit view formed when an outside touch is generated on a touch screen according to the present invention, and FIGS. 6 and 9 are graphs showing charging/discharging characteristics of a touch screen according to the present invention. Hereinafter, a method of detecting coordinates of a touch screen according to the present embodiment will be described with reference to these figures.

In order to perform the functions as described above, a controller 150 included in the touch screen according to the present invention includes a charging/discharging measuring unit 151, a coordinate detecting unit 152, a resistance measuring unit 153, a correction updating unit 154, and a memory unit 155.

The charging/discharging measuring unit 151 measures the charging/discharging characteristics of charges for the electrode patterns 120. The charging/discharging characteristics correspond to the change in voltage (or a voltage change curve) of the electrode patterns 120 according to time when a predetermined amount of charges are charged or discharged.

When an outside touch is generated on the touch screen, an equivalent circuit including a resistance component and a capacitance component is formed as shown in FIG. 5. FIG. 5 shows the resistance component and the capacitance component, for the cross-sectional view in an X direction of the touch screen as shown in FIG. 3.

A first capacitance C₁ is formed between a touched surface and a ground surface, a second capacitance C₂ is formed between the touched surface and the electrode pattern 120, crossing the protective layer 140, and two resistors R: R₁ and R₂ are generated across the electrode pattern 120 along the longitudinal direction of the electrode pattern 120. At this time, the second capacitance C₂ is determined by the dielectrics and the thickness of the protective layer 140 (when the touch area is constant) and the two resistors are determined by the distance between the touched point and both ends of the electrode pattern 120 and the surface resistance value of the electrode pattern.

As shown in FIG. 6, when the charging/discharging characteristics measured on the electrode pattern 120 have variation smaller (graph (4)) than the reference voltage variation value (graph (1)), the charging/discharging measuring unit 151 determines that an outside touch is not generated, and when the charging/discharging characteristics measured on the electrode pattern 120 have variation larger (graph (2) or graph (3)) than the reference voltage variation value, the charging/discharging measuring unit 151 determines that an outside touch is generated.

When the charging/discharging measuring unit 151 determines that an outside touch is generated, the coordinate detecting unit 152 calculates an X coordinate and a Y coordinate of the touched point.

Referring to FIG. 6, graph (1) shows the reference voltage variation value, graphs (2) and (3) show the discharging characteristics when a touch is generated on the protective layer 140, and graph (4) shows natural discharging characteristics when a touch is not generated. In this case, each of the graphs shows cases assuming that the electrode patterns are charged with initial voltage V₀ by a charge supply source. The touch screen includes the electrode wirings connected to both ends of the electrode patterns, respectively. FIG. 6 shows only the discharging characteristics measured through the electrode wirings connected to one of both ends of the electrode patterns.

When a touch is generated, a charge redistribution phenomenon occurs between the charge supply source and the RC equivalent circuit, thereby causing the change in voltage as shown in graph (2) or graph (3). At this time, the change in voltage is different according to the positions where the touch is generated. This is the reason that the time constant determining the change in voltage according to time depends on resistance R and capacitances C₁ and C₂.

The resistance R is differently determined according to the distance from the touched point to one end of the electrode pattern 120. The coordinate information on the touched point may be obtained thereby. If synthesis capacitance of the capacitances C₁ and C₂ is represented by C, the time constant τ and the change in voltage V(t) may be represented by the following Equation 1 and Equation 2.

τ=R×C [Equation 1]

V(t)=V_{f}+(V₀−V_{f})e^{(-t/τ)} [Equation 2]

In Equation 2, V_{f} represents final voltage after the charge redistribution according to the touch is completed. Graph (2) and graph (3) show cases assuming that the touch is generated at different positions. Therefore, it can be appreciated that the change in voltage varies depending on the time constant τ determined according to the resistance R and the capacitances C₁ and C₂.

Comparing graph (2) with graph (3), it can be appreciated that the graph (2) showing the abrupt change in voltage according to time has a small resistance R, assuming that the capacitances are the same. Therefore, in the case of graph (2), it can be appreciated that the position of the touched point is closer to one end of the electrode pattern, as compared to graph (3).

In other words, it can be appreciated that the time constant τ has a smaller value as the change in voltage is abruptly made according to time. This is the reason that the resistance component R determining the time constant τ is small. Therefore, assuming that the surface resistance is the same, the distance between the touched point to one end is in proportion to the time constant τ. Meanwhile, when the change in voltage is measured through the electrode wiring connected to other end of the electrode pattern, it is obvious that graph (2) and graph (3) are exchanged. Therefore, the detailed description thereof will be omitted.

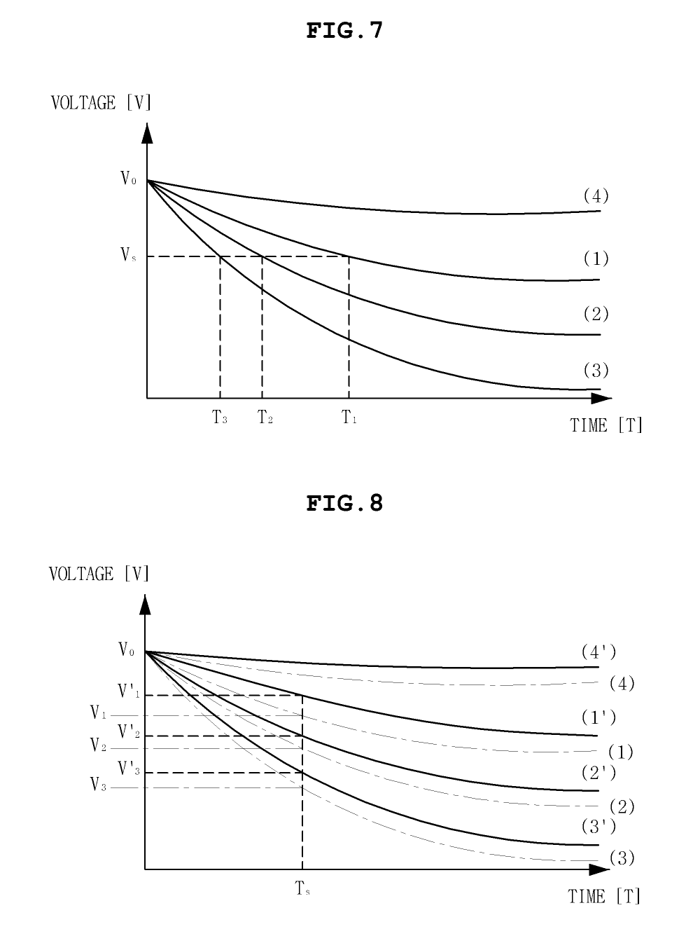

The coordinate detecting unit 152 sets a predetermined threshold time Tₛ for the charging/discharging characteristics measured by the charging/discharging measuring unit 151 and calculates an X coordinate using the change in voltage shown in a period from the time point where the touch is generated (assumed as 0 in FIGS. 6 and 7) to the threshold time Tₛ. Referring to FIG. 6, the voltage is changed from V₀ to V₂ during the threshold time Tₛ in graph (2), and the voltage is changed from V₀ to V₃ during the threshold time Tₛ in graph (3).

A lookup table stored in the memory unit 155 includes different coordinate tables according to various reference voltage variation values, wherein the coordinate table includes an X coordinate value and a Y coordinate value according to the voltage value. In this case, the coordinate detecting unit 152 selects the coordinate table according to an initial reference voltage variation value and then selects an X coordinate value corresponding to the voltage value according to the threshold time.

As another method of calculating an X coordinate value, the coordinate value may be calculated using time taken in changing voltage to the threshold voltage Vₛ as shown in FIG. 7. Referring to FIG. 7, a time taken in reaching the threshold voltage Vₛ is measured as T₂ in graph (2) and is measured as T₃ in graph (3). As a result, the X coordinate values according to T₂ and T₃ are determined.

The touch screen 100 according to the present invention measures all of the discharging characteristics of the electrode patterns 120 generated through the electrode wirings 130 connected to both ends of the electrode patterns 120 and normalizes the coordinate information obtained thereby, thereby making it possible to calculate a more precise X coordinate.

The plurality of electrode patterns 120 are formed in parallel, such that each of the electrode patterns has a unique Y coordinate value and the Y coordinate value owned by the electrode pattern is determined as the Y coordinate of the touched point as compared to other electrode patterns.

In other words, the electrode pattern far from the touched point may have the change in voltage similar to graph (4), and the electrode pattern 120 adjacent to the touched point may have the change in voltage as shown in graph (2) or graph (3). When the charging/discharging measuring unit 151 scans the plurality of electrode patterns, the coordinate detecting unit 152 detects an electrode pattern having the most abrupt change in voltage based thereon to determine a Y coordinate. Meanwhile, a more precise Y coordinate may also be calculated by measuring the change in voltage generated in the electrode pattern disposed adjacent to the electrode pattern having the greatest change in voltage.

The electrode pattern is made of a conductive material such as ITO, wherein the conductive material may have surface resistance that changes according to the external environment, that is, temperature or moisture. When the surface resistance is changed, the time constant τ is changed. Therefore, if the coordinate point is calculated based on the coordinate table depending on the reference voltage variation value according to the prior art, the touch screen malfunctions.

In particular, in the case of the conductive polymer having weak heat-resistance and humidity-resistance, the touch screen has a higher possibility of malfunctioning. In the case of the conductive polymer, the surface resistance thereof increases at high-temperature and high-humidity. As a result, even in the case in which the touch is generated under the same condition, the voltage variation is reduced in the graphs shown in FIGS. 6 and 7, similar to the graphs shown in FIGS. 8 and 9.

When the coordinate point is calculated using the coordinate table according to the prior art, the voltage is changed from V₀ to V′₂ during the threshold time Tₛ in graph 2′ and the voltage is changed from V₀ to V′₃ during the threshold time T₂ in graph 3′, such that errors occur in the X coordinates by the difference between V₂ and V′₂ and the difference between V₃ and V′₃. In other words, the X coordinates of the touched point is measured to be farther from one end of the electrode pattern.

In this case, the resistance measuring unit 153 measures the surface resistance of the electrode pattern using the voltage and current characteristics generated from the electrode pattern, the correction updating unit 154 updates the reference voltage variation value using the resistance value of the electrode pattern measured by the resistance measuring unit 153. The updated reference change variation value (for example, graph (1′)) is measured in the memory unit 155.

The memory unit 155 supplies the coordinate table depending on the voltage variation value updated according to the signal from the coordinate detecting unit 152 to the coordinate detecting unit 152.

As described above, the X coordinate value is calculated based on the reference voltage value on which the surface resistance value of the electrode pattern changed according to the external environment is reflected and the coordinate table accordingly thereof, thereby making it possible to calculate accurate X coordinates even though the external environment is changed according to high-temperature and high-humidity.

The touch screen according to the present invention obtains more accurate coordinates of the touched point as compared to a resistive touch screen according to the prior art and has a simple structure as compared to a capacitive touch screen according to the prior art.

The touch screen according to the present invention measures the change in surface resistance of the electrode patterns and updates the reference voltage variation value based on the surface resistance value, thereby making it possible to accurately calculate the coordinates of the touched point even when the surface resistance value of the electrode pattern is changed according to the external environment.

The touch screen according to the present invention has the electrode patterns formed of a single layer to form a slim configuration, and calculates the coordinates of the touched point according to the charging/discharging characteristics of the RC equivalent circuit through the electrode wirings connected to both ends of the electrode patterns to accurately calculate the coordinates of the touched point.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch screen, comprising:
a base member;
a plurality of electrode patterns formed on one surface of the base member, having a first directionality;
electrode wirings connected to both ends of the electrode patterns; and
a controller that is connected to the electrode wirings, measures the change in resistance of the electrode patterns to update reference voltage variation value, and measures charging/discharging characteristics generated from the electrode patterns when an outside touch is generated to calculate coordinate information on a touched point.

2. The touch screen as set forth in claim 1, wherein the controller includes:
a charging/discharging measuring unit that measures the charging/discharging characteristics of the electrode pattern to determine whether an outside touch is generated;
a coordinate detecting unit that calculates coordinate information on the touched point by using the change in voltage of the charging/discharging characteristics;
a resistance measuring unit that measures the change in resistance of the electrode pattern;
a correction updating unit that updates the reference voltage variation value by using the resistance value of the electrode pattern measured by the resistance measuring unit; and
a memory unit that stores a lookup table showing a coordinate value according to the reference voltage variation value and stores the reference voltage variation value updated by the correction updating unit.

3. The touch screen as set forth in claim 1, wherein the plurality of electrode patterns have the same area and shape.

4. The touch screen as set forth in claim 1, wherein the plurality of electrode patterns are spaced from each other at the same interval.

5. The touch screen as set forth in claim 1, further comprising a protective layer that covers the plurality of electrode patterns.

6. The touch screen as set forth in claim 1, wherein the distal ends of the electrode wirings are collected at a connection unit formed on one surface of the base member.

7. The touch screen as set forth in claim 1, wherein the electrode pattern is made of a conductive polymer.

8. The touch screen as set forth in claim 7, wherein the conductive polymer includes PEDOT/PSS.
